(19) United States
(12) Patent Application Publication
(10) Pub. No.: US 2024/0325923 A1
(43) Pub. Date: Oct. 3, 2024

(54) PERSONALIZING ANIMATIONS FROM PLAYER PLAYSTYLE

(71) Applicant: Electronic Arts Inc, Redwood City, CA (US)

(72) Inventors: Ayleah Hill, Edmonds, WA (US); Fernando de Mesentier Silva, San Francisco, CA (US); Harold Henry Chaput, Castro Valley, CA (US)

(73) Assignee: Electronic Arts Inc, Redwood City, CA (US)

(21) Appl. No.: 18/194,425

(22) Filed: Mar. 31, 2023

(51) Int. Cl. A63F 13/67; A63F 13/52; A63F 13/56; A63F 13/65; A63F 13/79; G06T 13/00

(52) U.S. Cl. CPC A63F 13/67; A63F 13/52; A63F 13/56; A63F 13/65; A63F 13/79; G06T 13/00

(57) ABSTRACT

A personalization system determines a playstyle associated with a player of a gaming system based on gameplay information for the player and, for example, generates personalized animation for the player based on the player's playstyle. The personalization system can receive gameplay data associated with a playstyle of a player in one or more games and receive persona data associated with the player and the gameplay. The persona system can generate an animation for the player based on the gameplay data associated with the playstyle of the player in the one or more games, dynamically generate, based at least in part on a portion of the playstyle of the player, content including personalized animation, wherein the content including personalized animation is dynamically generated personalized content associated with the player, and transmit the content including personalized animation for presentation in a game associated with the player.

### BACKGROUND

Computer gaming allows gamers to play a variety of electronic and/or video games individually or with others over a network, such as the Internet. Computer gaming system(s) typically connect gamers who use their respective gaming devices over the network. In computer gaming, gaming animations typically are the same, e.g., same walking, same running, same fighting, for all gamers, without customization beyond generic avatars.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates a schematic diagram of an example environment with game system(s), game client device(s) and personalization system(s) that can enable computer gaming including the presentation of personalized animations from player playstyle, in accordance with examples described herein.

FIG. 2 illustrates a flow diagram of an example method to enable computer gaming including the presentation of personalized animations from player playstyle, in accordance with examples described herein.

FIG. 3 illustrates a flow diagram of an example method to enable computer gaming including the presentation of personalized animations from player playstyle, in accordance with examples described herein.

FIG. 4 illustrates a flow diagram of an example method to enable computer gaming including the presentation of personalized animations from player playstyle, in accordance with examples described herein.

FIG. 5 illustrates a chart of example player playstyles and personas including a determined persona and four playstyle values for a plurality of players in accordance with examples described herein.

FIG. 6 illustrates a block diagram of an example computing device associated with a personalization system(s) that can provide personalized animations from player playstyle, in accordance with examples described herein.

### DETAILED DESCRIPTION

Examples in this disclosure describe techniques, e.g., methods, apparatuses, computer-readable media, and/or systems, for determining a playstyle for a player using a gaming system based on gameplay information for the player and, for example, performing dynamic content generation including personalized animations from the player playstyle. It should be understood that, as used herein, a player can refer to (i) a person playing or participating in a video game; (ii) systems or devices corresponding to, associated with, operated by and/or managed by a player; and/or (iii) accounts and/or other data or collections of data associated with or corresponding to a player.

Players of computer games can have different ways of playing the same game while trying to achieve the same goal. Herein such different ways of playing are called playstyles. Examples described herein can observe different player personas based on different preferences or different approaches to experiencing games. Examples can collect and analyze gameplay data for players to determine trends in the player's preferences and approaches when playing games. Some example trends that can be determined from gameplay data can be related to exploring the environment, engaging in combat, searching for collectibles, completing challenges, obtaining achievements, etc. As a couple of examples, one player can aggressively engage in combat at every opportunity, while a different player actively explores as much of the map as possible. The system described herein can evaluate players' playstyle(s) and persona(s) and customize their characters animations to match so that individual players can enjoy unique experiences while gaming.

A personalization system can determine characteristics from gameplay data associated with a player. Gameplay data can include playstyle associated with player(s) of one or more games. Gameplay data can also include persona data associated with player(s) of one or more games. Persona data can be associated with player and gameplay data. In various examples, player personas can include a general persona classification and/or a collection of measurements for a plurality of persona dimensions. The persona dimensions for the above examples can include determined indicators of how much of time the player spent in combat; how much of a map did the player explore; how often did the player opt for harder/easier challenges, how fast was the player's progression in the main storyline (e.g., in relation to an average), etc. Playstyle, persona dimensions, and/or other gameplay data associated with a player data can be input to a classifier or regression algorithm that approximates players' preferences in relation to playstyle (e.g., aggressive, active, inquisitive, passive, etc.) and/or personas (e.g., competitor, explorer, completionism, etc.). For example, a player can be assigned a persona classification of explorer with persona dimension values of 55 for a combat dimension, 35 for a competition dimension, 65 for a collector dimension, and 85 for an exploration dimension. In such a case, the persona dimension values can represent a score on a normalized distribution in which the median or average player would be assigned a 50. In an example, the above set of values can indicate the player does not like competitive games, is relatively average in desiring combat, collects a lot of items or objects and explores more than almost all other players. The classifier can determine the player's archetype as explorer as this is the strongest dimension and the second strongest dimension (e.g., collector) tends to be strong in explorers but weaker than the explorer dimension due to the likelihood of finding and collecting items while exploring.

The playstyle characteristics can include indicators of how much of the player's time the player spent fighting and/or how quickly the player moved around the game to contribute to an aggressive playstyle; how much of the player's time was the player in motion, and how much of the player's time was the player interacting with other players in the game to contribute to an active playstyle; how much of the map did the player explore, and how much of the player's time was the player interacting with objects in the game to contribute to an inquisitive playstyle; how much of the player's time was the player stationary, and how much of the player's time was the player avoiding other players in the game to contribute to an passive playstyle, etc. Similarly, persona dimensions of the player personas can be generally derived from gameplay data from across multiple games. For example, the combat dimension of the player persona can be derived from gameplay data from multiple games including games of different genres (e.g., sports games, first person shooter games, role-playing games, flight simulation games, etc.). Similarly, dimensions of player personas may not necessarily be derived from or applicable to all games. For example, gameplay data from a solitaire card game can be omitted or minimally considered in deriving the combat dimension of a player persona (e.g., consideration can be limited to determining combat play emphasis among all gameplay data for the player).

Using player playstyle and persona derived from gameplay data from multiple games, examples can customize content presented to the player. Examples can present customized content in at least two contexts.

In some examples, the customized content can include a personalized animation based on a determination that the playstyle and/or persona associated with a current player are similar to the that of other players who have spent a lot of time in the new game. For example, a system can determine an average animation of other players who have spent a lot of time in a game that is new for the particular player.

In addition or alternatively, the customized content can include dynamically generated content including personalized animation in a game currently being played. In some examples, the playstyle, persona archetype, or persona dimensions can be used to inform a dynamic content system that can consider the player persona to customize the gameplay to either approximate or distance it from previous experiences. In various examples, a datastore or catalog of content generation algorithms and/or models for each game can be stored at the gaming systems and/or personalization systems for use in personalizing animations from player playstyles. For example, a set of content generation algorithms and/or models can be stored for a role-playing sports game, e.g., soccer, American football, hockey, basketball, etc., and/or other types of games as described herein.

In some examples, a set of content generation algorithms and/or models can include a content generation algorithm or model for dynamically generating level maps, a content generation algorithm or model for populating the level map with enemies or non-player characters, a content generation algorithm or model for adding challenges, puzzles or traps to the level map, a content generation algorithm or model for generating loot or item drops, a content generation algorithm or model for generating missions, and so on. Each of the content generation algorithms or models can generate content based in part on the player playstyle and/or persona such that players with different player playstyle and/or personas can be presented with different dynamically generated content including animations. In operation, the gaming system or persona system can retrieve an algorithm and/or model corresponding to the content to be dynamically generated and input at least a portion of the player's playstyle and/or persona into the algorithm and/or model generate the desired content based at least in part on the player's player playstyle and/or persona.

Building the player playstyles and/or personas from gameplay data collected across multiple games can provide more robust results. For example, because the player playstyles and/or personas can be built from gameplay data collected across multiple games, dynamically generated customized content including personalized animations can be provided even when a player has not had much interaction with the title (e.g., without a lag time to collect gameplay data for the current title).

Of course, embodiments are not limited to the specific examples given herein. For example, a player's persona can differ based on context. For example, a player's persona can be different depending on the type of game and/or character driven role the player can be performing. Some example contexts can be character or setup related such as character class, team choice, position or role preference, and so on. In a particular example, the player can have different in-game content preferences when playing a tank or defensive role from when the player plays the same game or type of game as a healer or support role. In some examples, each player can be associated with one or more player personas that correspond to different contexts. In such examples, dynamically generated content for a player can differ based on which player persona can be applied to the current context. In other examples, contextual preferences of the player can be built into the same player persona, such that different portions can be utilized in different contexts.

The player persona of each of the players can be associated with the respective players by way of a user account of the corresponding player. The user account for each of the players can associate various information about the respective players, in addition to his or her player persona, and can be stored in a player datastore and accessed by one or more persona system(s).

Further, as players engage in additional gameplay, the persona system(s) disclosed herein can perform additional training or otherwise update player personas based on additional gameplay information. In this manner, the player personas can be refined or evolve to provide customized content to the players, even if the players' behaviors, preferences and playstyle evolve over time.

Certain examples, implementations, and embodiments of the disclosure will now be described more fully below with reference to the accompanying figures, in which various aspects are shown. However, the various aspects can be implemented in many different forms and should not be construed as limited to the implementations set forth herein. It will be appreciated that the disclosure encompasses variations of the embodiments, as described herein. Like numbers refer to like elements throughout.

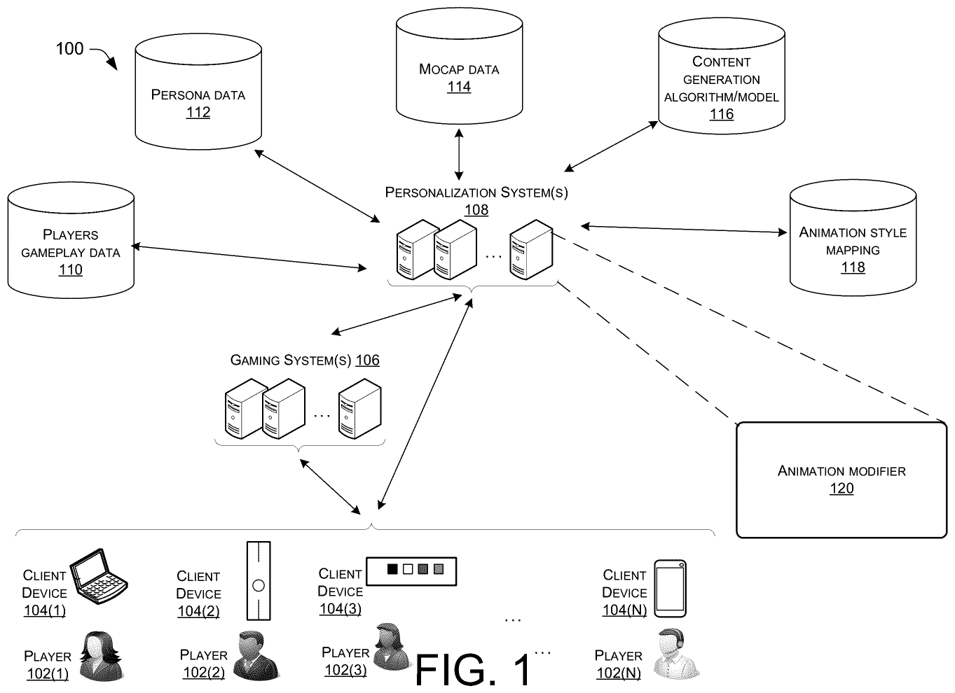

FIG. 1 illustrates a schematic diagram of an example environment 100 for personalizing animations from player playstyle as described herein. The example environment 100 can be used by any number of video-game players 102(1)-102(n), hereinafter referred to individually or collectively as player(s) 102, with their associated client devices 104(1)-104(n), hereinafter referred to individually or collectively as client device(s) 104 via respective input device(s). In various instances client device(s) 104 can connect to gaming system(s) 106, e.g., online gaming system(s), that can facilitate game play among and between video-game players, receive feedback from client devices 104(1)-104(n), and provide updates to video-game software on client device(s) 104, etc. As illustrated, online gaming system(s) 106 can be connected to personalization system(s) 108, which has one or more associated datastores and associated programming, that can include a players' gameplay datastore 110, a persona datastore 112, a motion-capture (mocap) datastore 114, a content generation algorithm/model datastore 116, an animation style mapping datastore 118, and an animation modifier 120. The datastores store datasets that personalization system(s) 108 can access to develop and improve video game experiences for player(s) 102 using personalizing animations from player playstyle. In various examples, these video games and improvements can be provided to client device(s) 104 directly from personalization system 108 and/or via online gaming system(s) 106.

According to some examples, players gameplay datastore 110 can store gameplay data from player(s) 102 playing game(s). Gameplay data can include playstyle and other characteristics that can contribute to a player(s) persona.

In various examples, persona datastore 112 can store calculated persona data determined by applying a classification and/or a regression algorithm, e.g., from the content generation algorithm/model datastore 116 to player characteristics from gameplay data.

In at least one example, mocap datastore 114 can store motion-capture data from actors and/or athletes performing actions for representation in a game and/or as captured from in real-life (IRL) game(s), e.g., from IRL American football games, IRL soccer games, IRL hockey games, IRL basketball games, etc.

According to some examples, content generation algorithm/model datastore 116 can store a variety of algorithms, including clustering algorithms, and/or models, such as K-Nearest Neighbors (KNN) algorithm(s), various classification algorithm(s) and/or models, linear or logistic regression algorithm(s), geometric interpolation algorithm(s), support vector machine(s), decision tree(s), neural network(s), etc.

In various examples, animation style mapping datastore 118 can store mapping data of known persona(s) and/or playstyle(s) to existing animation(s). For example, a known aggressive persona and/or known fighter playstyle can be mapped to an energetic and quick animation, e.g., depicting running, walking, fighting, attempting to score, defending, etc., whereas a known explorer personal and/or known vigilant playstyle can be mapped to a cautious and slower animation e.g., depicting running, walking, fighting, attempting to score, defending, etc.

In at least one example, animation modifier 120 can apply mapping data from animation mapping datastore 118 and player persona data as determined by application of one or more algorithm(s) and/or model(s) from content generation algorithm/model datastore 116, which can be used to modify existing animation(s) to generate personalized animation(s) associated with individual player(s) persona(s) and/or playstyle(s). Such personalized animation(s) can represent modification of existing animation(s), e.g., depicting running, walking, fighting, attempting to score, defending, etc.

The client device(s) 104 can receive game state information from the one or more gaming system(s) 106 that can host games played by the player(s) 102 of environment 100. Game state information can be received repeatedly and/or continuously and/or as events of games transpire. Game state information can be based, at least in part, on interactions that individual of the player(s) 102 has in response to events of the game hosted by gaming system(s) 106. Though discussed primarily herein in the form of an online game, examples are not so limited and can include single player or non-online gaming in which game state data can be uploaded to the gaming system(s) 106 and/or personalization system(s) 108 for use in providing personalized animations based on player playstyle, but in which the other operations of the gaming system(s) 106 are provided by the client device(s) 104.

The client device(s) 104 can be configured to render content associated with games to respective players 102 based at least on the game state information. More particularly, client device(s) 104 can use the most recent game state information to render current events of the game as content. This content can include video, audio, haptic, combinations thereof, etc., content components.

As events transpire in a game, gaming system(s) 106 can update game state information and send that game state information to client device(s) 104. For example, if players 102 are playing an online soccer game, and a player 102 playing one of the goalies moves in a particular direction, then that movement and/or goalie location can be represented in the game state information that can be sent to each of the client device(s) 104 engaged with the game for rendering the event of the goalie moving in the particular direction. In this way, the content of the game is repeatedly updated throughout game play.

When the client device(s) 104 receive the game state information from the gaming system(s) 106, client device(s) 104 can render updated content associated with the game for viewing by its respective player 102. This updated content can embody events that have transpired since the previous state of the game (e.g., the movement of the goalie).

The client device(s) 104 can accept input from respective player(s) 102 via respective input device(s). The input from the player(s) 102 can be responsive to events in the game. For example, in an online basketball game, if player 102 sees an event in the rendered content, such as an opposing team's guard blocking a shot, the player 102 can use his/her input device to recover the ball and try to shoot a three-pointer. The intended action by the player 102, as captured via his/her input device, can be received by the client device 104 associated with the player 102 and sent to the gaming system(s) 160.

The client device(s) 104 can represent any suitable device, including, but not limited to a Sony Playstation® line of systems, a Nintendo Switch® line of systems, a Microsoft Xbox® line of systems, any gaming device manufactured by Sony, Microsoft, Nintendo, or Sega, an Intel-Architecture (IA)® based system, an Apple Macintosh® system, a netbook computer, a notebook computer, a desktop computer system, a set-top box system, a handheld system, a smartphone, a personal digital assistant, combinations thereof, or the like. In general, the client device(s) 104 can execute programs thereon to interact with the gaming system(s) 106 and render game content based at least in part on game state information received from the gaming system(s) 106. Additionally, the client device(s) 104 can send indications of player input to the gaming system(s) 106. Game state information and player input information can be shared between the client device(s) 104 and the gaming system(s) 106 using any suitable mechanism, such as application program interfaces (APIs).

The gaming system(s) 106 can receive inputs from various player(s) 102 and update the state of an online game based thereon. As the state of the online game is updated, the state can be sent to the client device(s) 104 for rendering online game content to players 102. In this way, the gaming system(s) 106 can host the online game.

Example environment 100 can further include personalization system(s) 108 that can be configured to collect gameplay data associated with player(s) 102, generate personalized animation(s) for the player(s) 102, and utilize the personalized animation(s) to provide playstyle-driven dynamic content such as dynamically generated in-game content based on player playstyles and/or personas. In some examples, the example environment 100 can further include one or more persona system(s) (not shown) that can be configured to collect gameplay data associated with player(s) 102, generate player personas for the player(s) 102.

During operation, the personalization system(s) 108 can receive an indication from the gaming system(s) 106 that playstyle-driven dynamic content, e.g., personalized animations, is to be presented to the players 102 along with information that can be utilized in generating the content. For example, the personalization system(s) 108 can receive a request for a particular instance of playstyle-driven dynamic content (e.g., a request for specified dynamically generated in-game content such as a map, an enemy population, a loot drop, etc.). The received request can further include an identifier of the player (e.g., an identifier usable with a player gameplay datastore 110 and/or a persona datastore 112 to obtain gameplay and/or persona information associated with the player).

Using the player identifier and the parameters of the request, the personalization system(s) 108 can determine player playstyle data for the identified player 102. If the persona datastore 112 includes an up-to-date player persona for the identified player, the personalization system 108 can retrieve the existing player persona of the identified player. Otherwise, the personalization system(s) 108 can initially select a game from a list of games already associated with the identified player 102. The personalization system(s) 108 can then extract gameplay data for the identified player 102 for the selected game. For example, the personalization system(s) 108 can extract the gameplay data from the player gameplay datastore 110. As mentioned above, the player gameplay datastore can include records for an account for each of the players 102. The account can associate various information about the respective players 102 and can be stored in a datastore, e.g., the player gameplay datastore 110, and accessed by the personalization system(s) 108.

The player persona associated with a player can be stored in the persona datastore 112. While the persona datastore 112 is illustrated and described herein as a separate datastore from the player gameplay datastore 110, implementations are not so limited and can include a datastore that combines the persona datastore 112 and the player gameplay datastore 112.

The personalization system(s) 108 can fulfill requests for the playstyle-driven dynamic content.

In addition or alternatively, in response to a request for dynamically generated custom content in a game currently being played (e.g., a programmatically built map that is customized for exploration), the personalization system 108 can retrieve one or more dynamic content generation algorithms or models from a dynamic content generation algorithm or model datastore 116. The dynamic content generation algorithm or model datastore 116 can store dynamic content generation algorithms or models for a plurality of games. More particularly, the personalization system(s) 108 can retrieve a dynamic content generation algorithm or model that is configured to utilize a player's playstyle and/or persona to inform dynamic content generation (e.g., consider the player playstyle and/or persona to customize the animation(s) for presentation during gameplay to either approximate or distance them from previous experiences) for particular content. In operation, the gaming system(s) 106 or personalization system(s) 108 can retrieve corresponding algorithm(s) or model(s) by querying the content generation algorithm or model datastore 116 based on the game and/or details of the request to obtain one or more corresponding content generation algorithm(s) or model(s). Each of the content generation algorithm(s) or model(s) can generate content based in part on player playstyle(s) and/or persona(s) such that players with different player playstyle(s) and/or persona(s) can be presented with different personalized animation(s).

The content generation algorithms or models can include certain algorithms customized to use certain metrics and dimensions to inform the generation of the output of the content generation algorithm or model. In some examples, the content generation algorithm or model can include one or more evolutionary algorithm(s). Such algorithms can be inspired by the biological evolutionary process. An evolutionary dynamic content generation algorithm can start by generating (e.g., randomly) several candidates, which would configure a population. The algorithm can then evaluate each candidate based on a fitness function. A set of candidates can then be selected based on their fitness score. The selected candidates can then be submitted to a combination of mutation (e.g., in which a small change can be made to an individual candidate's representation), and crossover (e.g., in which parts of the representation of two or more individual selected candidates can be stitched together to create new candidate(s)). This process (e.g., from fitness evaluation to mutation and crossover) can be repeated until a certain criteria is met (e.g., either a set fitness score is met by the current population of candidates or the process has been repeated a fixed number of times). In this scenario, a metric can be referred to in the fitness function (e.g., for weighting different dimensions of gameplay).

After personalization system(s) 108 has retrieved an algorithm or model, the personalization system(s) 108 can be configured to input at least a portion of the player's player playstyle and/or persona into the algorithm or model to generate visual content, e.g., animation, based on the player playstyle and/or persona (e.g., such that the generation of the content is influenced by the player's associated playstyle and/or persona). The personalization system(s) 108 can then return the content generated by the algorithm or model to the gaming system(s) 106 for presentation to the player 102 as personalized animation in gameplay.

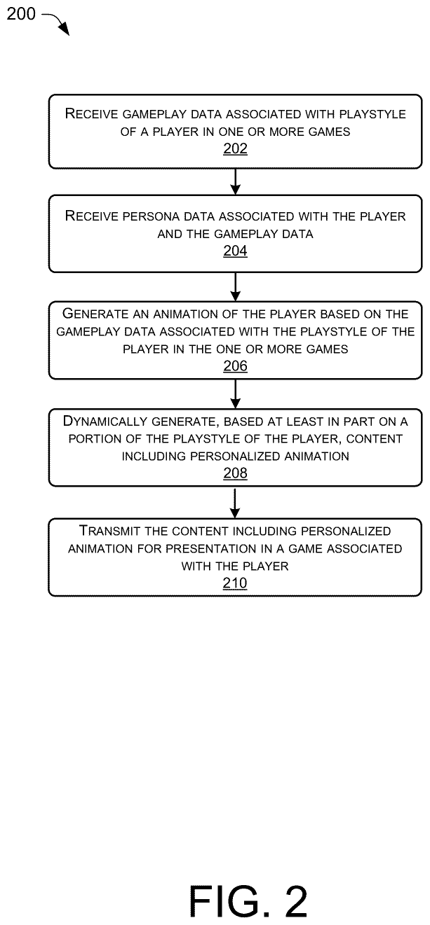

FIG. 2 illustrates a flow diagram of an example method 200 to enable computer gaming including the presentation of personalized animations from player playstyle, in accordance with examples described herein. Method 200 can be performed by the personalization system(s) 108, individually or in cooperation with one or more other elements of the environment 100.

At block 202, personalization system(s) 108 can receive gameplay data associated with playstyle of a particular player 102 in one or more games. Games can belong to a variety of genres such as sports games, first person shooter games, role-playing games, flight simulation games, etc., each of which can include a variety of characteristics. For example, game characteristics can suggest a genre associated with a game, a history of characteristics associated with the player and the genre, one or more filters, etc. A particular player 102 can be identified by the personalization system(s) 108 based at least in part on a message and/or an indication from the gaming system(s) 106 and/or client device(s) 104. In examples, a player identifier, such as a player account login and/or other profile information, corresponding to an individual player 102 can be used to identify the particular player 102 for which playstyle-driven dynamic content including personalized animation is to be presented.

At block 204, personalization system(s) 108 can receive persona data associated with the particular player 102 and the gameplay data. In some examples, personalization system(s) 108 can store the received persona data in persona datastore 112 and/or the received gameplay data in gameplay datastore 110. In various example, personalization system(s) 108 can retrieve stored persona data from persona datastore 112 and/or retrieve stored gameplay data from gameplay datastore 110.

At block 206, personalization system(s) 108 can generate an animation for the particular player 102 based on the gameplay data associated with the playstyle of the particular player 102 in one or more games. In some examples, block 206 can include the personalization system 108 determining whether to perform an update of the persona associated with the particular player 102 or if an up-to-date player persona is available for the particular player 102 in the persona datastore 112.

At block 208, personalization system(s) 108 can dynamically generate, based at least in part on a portion of the playstyle of the player, content including personalized animation. In some examples, personalized animation can be dynamically generated in a game currently being played by the particular player 102. In various examples, personalized animation can be based, at least in part, on additional gameplay data associated with additional gameplay of the particular player 102 during one or more additional games. In at least one example, personalized animation can be based, at least in part, on an animation modifier 120 creating a blended animation associated with the playstyle of the particular player 102.

At block 210, personalization system(s) 108 can transmit the content including personalized animation for presentation in a game associated with the player.

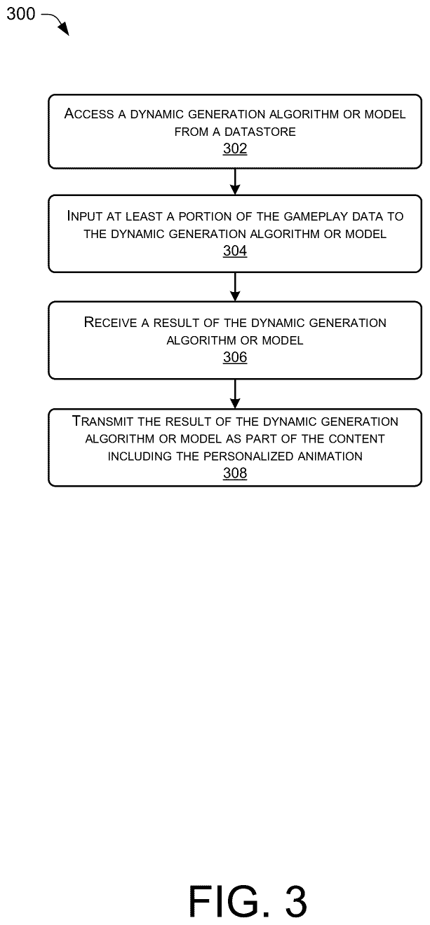

FIG. 3 illustrates a flow diagram of an example method 300 to enable computer gaming including the presentation of personalized animations from player playstyle, in accordance with examples described herein. More particularly, method 300 can enable the presentation of customized content (e.g., personalized in-game content) generated based on a player playstyle and/or persona. In some examples, the method 300 follows method 200. However, examples are not so limited and methods 200 and 300 can both be performed separately or in conjunction. The method 300 can be performed by the personalization system(s) 108, individually or in cooperation with one or more other elements of the environment 100.

At block 302, personalization system(s) 108 can access a dynamic generation algorithm or model from content generation algorithm/model datastore 116. In various examples, the dynamic generation algorithm or model is associated with the gameplay based on the persona of the player.

In some examples, personalization system(s) 108 can retrieve a content generation algorithm associated with a specific game. The dynamic content generation algorithm or model datastore 116 can store dynamic content generation algorithms or models for a plurality of games.

At block 304, personalization system(s) 108 can input at least a portion of the gameplay data to the accessed dynamic generation algorithm or model. In examples, the personalization system(s) 108 can access one or more dynamic content generation algorithm(s) and/or model(s) that are configured to utilize the player's playstyle and/or persona to inform dynamic content generation (e.g., consider the player playstyle and/or persona to customize personalized animation to either approximate or distance it from previous experiences) for particular content. In operation, the gaming system 106 and/or personalization system 108 can retrieve corresponding algorithm(s) and/or model(s) by querying the dynamic content generation algorithm or model datastore 116 based on the game and/or gameplay data to obtain at least one corresponding dynamic content generation algorithm and/or model. Dynamic content generation algorithms or models can generate content based in part on the player's playstyle and/or persona such that players with different playstyles and/or personas can be presented with different animations personalized for the different players during gameplay.

In various examples, personalization system(s) 108 can dynamically generate custom content based on the accessed algorithm and/or model and the playstyle and/or persona associated with a player from one or more games. For example, the personalization system(s) 108 can be configured to input at least a portion of the player's playstyle into the algorithm or model to generate content based on the player's playstyle (e.g., such that the generation of animation associated with the player is influenced by the player playstyle). In a particular example, AI agents can be trained to approximate the behavior of different player playstyles. For example, one AI agent can be trained to mimic an aggressive playstyle, one AI agent can be trained to mimic an active playstyle, one AI agent can be trained to mimic an inquisitive playstyle, one AI agent can be trained to mimic a passive playstyle, and so on. The AI agents can be trained using various approaches. For example, an AI agent can be trained using imitation learning (e.g., where gameplay data from players that represent that persona can be fed to the agent) or by evolving a Monte Carlo Tree Search (MCTS) policy (e.g., where the system can use an evolutionary algorithm to shape a policy function of a MCTS agent, evaluate the gameplay data from that agent in order to classify what playstyle it would be, and choose the policy that best approximates a particular playstyle). Once AI agent(s) are trained, the system can utilize a search-based approach (e.g., an Evolutionary Algorithm) to generate multiple potential versions of the animation. The system can then have the AI agents play a series of games using the multiple potential versions and evaluate the versions according to certain features. For a generated map to be explored, these features can be how many times the agent succeeded in completing a level, how many collectibles the agent found, how many enemies the agent engaged with, etc. For a generated fight, the features can be how many enemies the agent defeated, how many shots the agent fired, how many times the agent missed a shot, the average distance in combat from enemies to the agent, etc. Then, the system can utilize a function to weight these different features to score versions of the animations in relation to the different playstyles and/or personas.

At block 306, personalization system(s) 108 can receive a result of the dynamic generation algorithm or model.

At block 308, personalization system(s) 108 can transmit the result of the dynamic generation algorithm and/or model as part of the content including the personalized animation. For example, personalization system(s) 108 can transmit the result including the personalized animation to the gaming system(s) 106 and/or client device(s) 104 for presentation in the game associated with the player(s) 102 during gameplay.

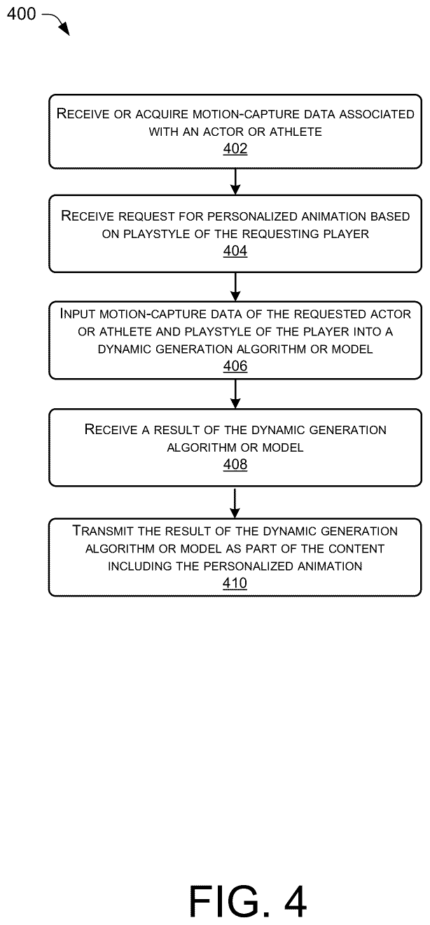

FIG. 4 illustrates a flow diagram of an example method 400 to enable computer gaming including the presentation of personalized animations from player playstyle, in accordance with examples described herein. More particularly, method 400 can enable the presentation of presentation of customized content (e.g., personalized in-game content) generated based on a player playstyle and/or persona. In some examples, the method 400 follows method 200. However, examples are not so limited and methods 200 and 400 can both be performed separately or in conjunction. The method 400 can be performed by the personalization system(s) 108, individually or in cooperation with one or more other elements of the environment 100.

At block 402, the personalization system(s) 108 can receive or acquire motion-capture data associated with an actor or athlete, e.g., from mocap datastore 114. In at least one example, personalization system(s) 108 can extract characteristics associated with an actor or athlete in the motion-capture data. For example, the characteristics can include parameters that specify a genre of a game associated with the particular motion-capture data associated with a particular actor or athlete.

At block 404, the personalization system(s) 108 can receive a request for personalized animation based on the playstyle of the player. For example, a particular player 102 can indicate a desire to have an animation presented based on a particular character, athlete, etc. In response, the personalization system(s) 108 can select motion-capture data associated with the actor or athlete to inform generation of personalized animation for the player 102.

At block 406, the personalization system(s) 108 can input the motion-capture data associated with the requested actor or athlete and at least a portion of the gameplay data including playstyle of the player into a dynamic generation algorithm or model. In some examples, personalization system(s) 108 can determine whether to perform an update of existing playstyle and/or persona data associated with the player 102 based at least in part on recency of data in the gameplay datastore 110 and/or persona datastore 112 associated with the player. For example, if one or more of playstyle and/or persona data associated with the player 102 has not been updated for a predetermined period of time, e.g., since the last time the player 102 played the game, in a day, a week, etc. . . . , personalization system(s) 108 can update the playstyle and/or persona data associated with the player 102. Additionally or alternatively, if one or more of playstyle and/or persona data associated with the player 102 is not based, at least in part, on the requested actor or athlete, personalization system(s) 108 can update the playstyle and/or persona data associated with the player 102.

At block 408, the personalization system(s) 108 can receive a result of the dynamic generation algorithm or model. In various examples, personalization system(s) 108 can access or retrieve the result of the dynamic generation algorithm or model. In various examples, personalization system(s) 108 can update the playstyle and/or persona data associated with the player 102 based on the result.

At block 410, the personalization system(s) 108 can transmit the result of the dynamic generation algorithm or model as part of the content including the personalized animation for presentation in the game associated with the player 102. In at least one example, a dynamic generation algorithm or model can map at least a portion of the playstyle of the player to at least a portion of the motion-capture data associated with the actor or athlete.

It should be noted that some of the operations of methods 200, 300, and/or 400 can be performed out of the order presented, with additional elements, and/or without some elements. Some of the operations of methods 200, 300, and/or 400 can further take place substantially concurrently and, therefore, can conclude in an order different from the order of operations shown above.

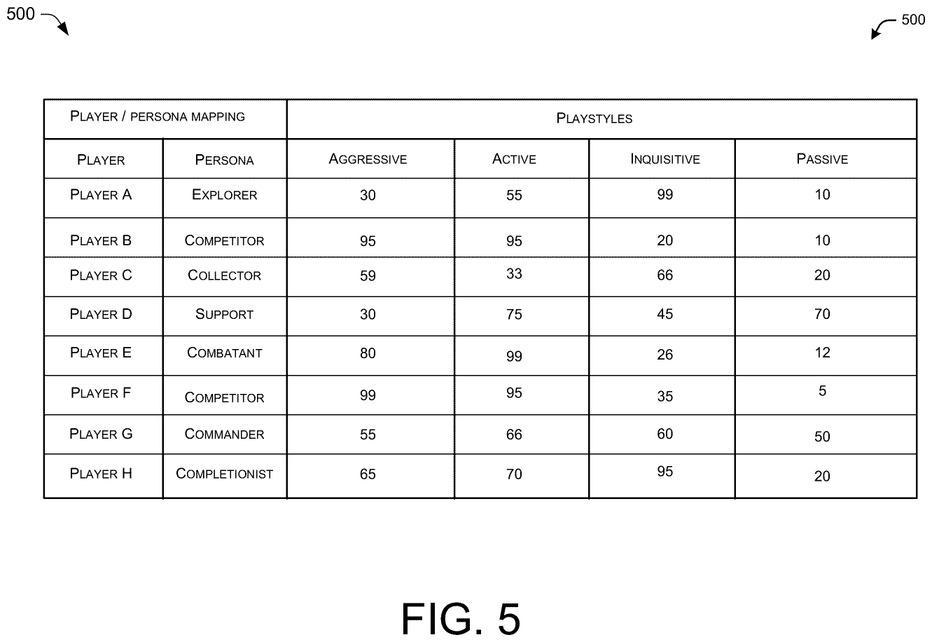

FIG. 5 illustrates a chart 500 of example player playstyles and personas including a determined persona and four example playstyles (e.g., aggressive, active, inquisitive, and passive), though other examples could be consistent with this disclosure.

The chart 500 shows a number of players, such as player A through player H who have corresponding player personas as shown. For example, player A has a persona of explorer and an inquisitive playstyle value of 99 and an active playstyle value of 55, while player C has a persona of collector and an inquisitive playstyle value of 66 and an aggressive playstyle value of 59. The example playstyles and personas shown in this example are non-limiting and many other suitable playstyles and personas would be apparent to one of ordinary skill in the art in view of this disclosure. Similarly, the playstyles used in this example can each be on a 0-100 range, but any suitable range (e.g., 0-1, 0-50, etc.) can be used consistent with examples of this disclosure. Additionally or alternatively, playstyle values can be represented by a percentage, e.g., so that the total of the percentages for each player is 100%. For example, when represented as percentages, Player B's playstyle would be 43% aggressive, 43% active, 9% inquisitive, and 5% passive. As discussed above, playstyles can be determined by the personalization system(s) 108 based on gameplay data of the corresponding player, which can include identified playstyle(s) and/or persona(s). In example embodiments, the personalization system(s) 108, by using a player's identifier, can access the player's gameplay data from the player gameplay datastore 110 and access the player's persona from the persona datastore 112.

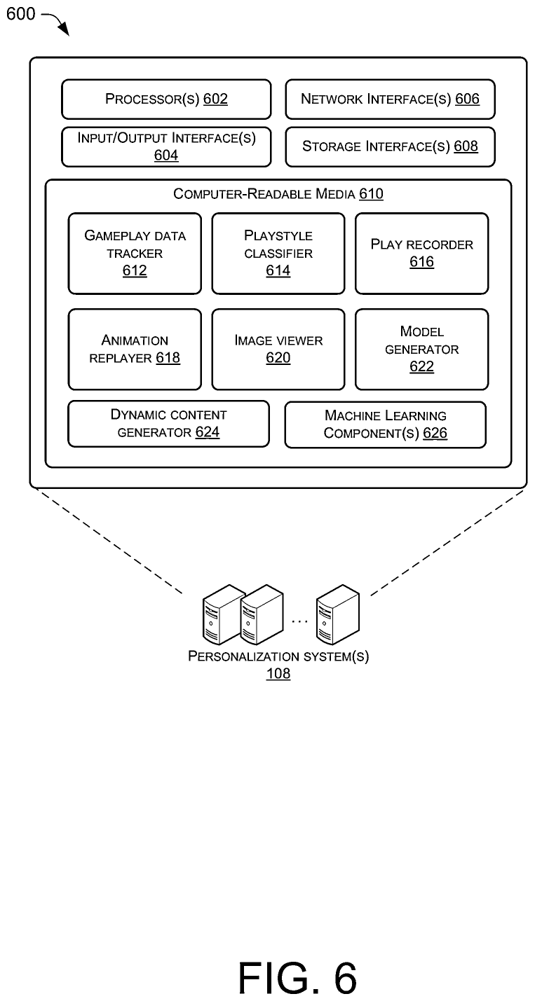

FIG. 6 illustrates a block diagram of an example computing device 600 associated with a personalization system(s) 108 that can provide personalized animations from player playstyle, in accordance with examples described herein. The computing device 600 can include one or more processor(s) 602, one or more input/output (I/O) interface(s) 604, one or more network interface(s) 606, one or more storage interface(s) 608, and computer-readable media 610.

In various examples, the processors(s) 602 can include one or more of a central processing unit (CPU), a graphics processing unit (GPU), a microprocessor, a digital signal processor, and/or other processing units or components. Alternatively, or in addition, the processing described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), quantum processors, etc. Additionally, each processor(s) 602 can possess its own local memory, which also can store programs, program data, and/or one or more operating systems. Furthermore, the one or more processor(s) 602 can include one or more cores.

The one or more input/output (I/O) interface(s) 604 can enable the computing device(s) 600 associated with personalization system(s) 108 to detect interaction with other computing system(s) such as gaming system(s) 106 and/or client device(s) 104. The I/O interface(s) 604 can include a combination of hardware, software, and/or firmware and can include software drivers for enabling the operation of any variety of I/O device(s) integrated on the computing device(s) 600 associated with personalization system(s) 108 or with which computing device(s) 600 associated with personalization system(s) 108 interact, such as displays, microphones, speakers, cameras, switches, and any other variety of sensors, or the like. In various examples, the I/O devices of the computing device(s) 600 associated with personalization system(s) 108 can include audio, video, and/or other input functionality.

The network interface(s) 606 can enable the computing device(s) 600 associated with personalization system(s) 108 to communicate via the one or more network(s). The network interface(s) 606 can include a combination of hardware, software, and/or firmware and can include software drivers for enabling any variety of protocol-based communications, and any variety of wireline and/or wireless ports/antennas. For example, the network interface(s) 606 can include one or more of a cellular radio, a wireless (e.g., IEEE 802.1x-based) interface, a Bluetooth® interface, and the like. In some examples, the network interface(s) 606 can connect to the Internet. The network interface(s) 166 can further enable the computing device(s) 600 associated with personalization system(s) 108 to communicate over circuit-switch domains and/or packet-switch domains.

The storage interface(s) 608 can enable the processor(s) 602 to interface and exchange data with computer-readable medium 610, as well as any storage device(s) external to the computing device(s) 600 of personalization system(s) 108, such as if any one or more of players gameplay datastore 110, persona datastore 112, mocap datastore 114, content generation algorithm/model datastore 116, and/or animation style mapping datastore 118 are implemented in separate computing device(s) associated with personalization system(s) 108. The storage interface(s) 608 can further enable access to removable media.

The computer-readable media 610 can include volatile and/or nonvolatile memory, removable and non-removable media implemented in any method or technology for storage of information, such as computer-executable instructions, data structures, program functions, or other data. Such memory includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media 610 can be implemented as computer-readable storage media (CRSM), which can be any available physical media accessible by the processor(s) 602 to execute instructions stored on the computer-readable media 610. In one example implementation, CRSM can include random access memory (RAM) and Flash memory. In other example implementations, CRSM can include, but is not limited to, read-only memory (ROM), electrically erasable programmable read-only memory (EEPROM), or any other tangible medium which can be used to store the desired information, and which can be accessed by the processor(s) 602. The computer-readable media 610 can have an operating system (OS) and/or a variety of additional suitable applications stored thereon. The OS, when executed by the processor(s) 602 can enable management of hardware and/or software resources of the computing device(s) 600 associated with personalization system(s) 108.

Several functional blocks having instructions and/or datastores consistent with instructions and/or datastores previously described herein, such as animation modifier 120, gameplay datastore 110, persona datastore 112, mocap datastore 114, content generation algorithm/model datastore 116, and/or animation style mapping datastore 118 can be stored within the computer-readable media 610 and configured to execute on the processor(s) 602. The computer-readable media 610 can also have stored thereon programming for additional related functionalities including a gameplay data tracker 612, a playstyle classifier 614, a play recorder 616, an animation replayer 618, an image viewer 620, a model generator 622, a dynamic content generator 624, and any number and/or type of machine-learning component(s) 626. It will be appreciated that each of the blocks 612, 614, 616, 618, 620, 622, 624, and 626 can have instructions stored thereon that when executed by the processor(s) 602 enable various functions pertaining to the operations of the computing device(s) 600 of personalization system(s) 108. It should further be noted that one or more of the functions associated with blocks 612, 614, 616, 618, 620, 622, 624, and 626 can operate separately or in conjunction with each other.

The instructions stored in the gameplay data tracker 612, when executed by the processor(s) 602, can configure the personalization system(s) 108 to identify player(s) and collect or track gameplay data from the player(s) and store the gameplay data in the player gameplay datastore 110. In some examples, the processor(s) 602 can request player identification information and gameplay data, such as from the gaming system(s) 106 and/or client devices(s) 104.

The instructions stored in the playstyle classifier 614, when executed by the processor(s) 602, can configure the personalization system(s) 108 to determine the playstyle of players based on the gameplay data tracked by the gameplay data tracker 612. For example, the processor(s) 602 can use gameplay data to determine playstyle including a persona classification and/or a collection of measurements for a plurality of playstyle characteristics. The playstyle characteristics can include indicators of how much of the player's time the player spent fighting and/or how quickly the player moved around the game to contribute to an aggressive playstyle; how much of the player's time was the player in motion, and how much of the player's time was the player interacting with other players in the game to contribute to an active playstyle; how much of the map did the player explore, and how much of the player's time was the player interacting with objects in the game to contribute to an inquisitive playstyle; how much of the player's time was the player stationary, and how much of the player's time was the player avoiding other players in the game to contribute to an passive playstyle, etc.

The persona dimensions and other player data can then be input to a model or algorithm that approximates players preferences in relation to general behavior personas or archetypes (e.g., competitor, explorer, completionism, etc.). Such persona data is not limited to particular persona data and can include other dimensions such as team history data, playstyle data,

The instructions stored in play recorder 616, when executed by processor(s) 602, can configure computing device(s) 600 of personalization system(s) 108 to record game play, such as for later replay and/or analysis. The computing device(s) 600 of personalization system(s) 108 can be configured to record one or more instances of play of a game for the purposes of generating synthetic-training data. This game play may be recorded and then replayed to identify one or more base playstyle(s) and/or general persona(s). The recording may be stored in memory, storage, or any suitable location.

The instructions stored in animation replayer 618, when executed by processor(s) 602, can configure computing device(s) 600 of personalization system(s) 108 to replay and annotate recorded animation. Training data can be generated from this replay and annotation process, which in turn can then be used to build predictive models that can be deployed in a game for real-time predictions of player and/or object locations, orientations, and/or features.

The instructions stored in image viewer 620, when executed by processor(s) 602, can configure computing device(s) 600 of personalization system(s) 108 to display images from a real-life dataset, such as images and associated motion-capture data from actors/athletes, which in some cases can be from actual sporting events. In some examples, personalization system(s) 108 can generate training data from this data, which in turn can then be used to build predictive models that can be deployed in a game for real-time presentation of predicted player and/or object locations, orientations, and/or features.

The instructions stored in model generator 622, when executed by processor(s) 602, can configure computing device(s) 600 of personalization system(s) 108 to generate predictive models. In some examples, the predictive models can be generated by the computing device(s) 600 of personalization system(s) 108. In other example embodiments, other systems, such as dedicated machine learning and/or heuristics systems can provide the modeling services. The predictive models may be any suitable type of predictive model, such as any variety of machine learning model corresponding to the variety of machine-learning components described herein, e.g., a logistic regression model, a neural network model, etc.

The instructions stored in the dynamic content generator 624, when executed by the processor(s) 602, can configure the personalization system(s) 108 to retrieve an algorithm or model corresponding to the custom content including personalized animation to be generated and input the player's playstyle and/or persona into the algorithm or model to generate the personalized animation based at least in part on the player's playstyle.

The instructions stored in machine-learning component(s) 626, when executed by processor(s) 602, can configure computing device(s) 600 of personalization system(s) 108 to use data structures and logic to process image and/or video data from gameplay and/or mocap data and can include a variety of types such as clustering, linear or logistic regression, semantic segmentation, classification networks, Multilayer Perceptrons (MLP), deep neural networks (DNN), convolutional neural networks (CNN), Long Short-Term Memory (LSTM) and/or other types of recurrent neural networks (RNN), recurrent and convolutional neural networks (R-CNN) and/or other types of machine-learning networks. A machine-learning component can operate on a variety of features within one or more machine-learning network types. In examples with a single sematic segmentation neural network type, a machine-learning component can operate on variety of features by using different network architectures (such as Hourglass, UNet, SegNet, SpineNet, etc.) and/or by varying a number of features per neural network type. The personalization system described herein can use many, e.g., dozens to hundreds, of separate simple augmented networks to leverage multi-processor architecture and parallelization of processing. In various examples, simple augmented networks can include one-feature, two-feature, three-feature, etc. networks. Machine-learning components can also include light-weight models such as a support vector machine (SVM), decision trees, random forest, Bayesian networks, or any suitable predictive models.

The illustrated aspects of the claimed subject matter can also be practiced in distributed computing environments where certain tasks are performed by remote processing devices that are linked through a communications network. In a distributed computing environment, program modules can be located in both local and remote memory storage devices.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

The disclosure is described above with reference to block and flow diagrams of system(s), methods, apparatuses, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams can not necessarily need to be performed in the order presented, or can not necessarily need to be performed at all, according to some embodiments of the disclosure.

Computer-executable program instructions can be loaded onto a general purpose computer, a special-purpose computer, a processor, or other programmable data processing apparatus to produce a particular machine, such that the instructions that execute on the computer, processor, or other programmable data processing apparatus for implementing one or more functions specified in the flowchart block or blocks. These computer program instructions can also be stored in a computer-readable memory that can direct a computer or other programmable data processing apparatus to function in a particular manner, such that the instructions stored in the computer-readable memory produce an article of manufacture including instruction that implement one or more functions specified in the flow diagram block or blocks. As an example, embodiments of the disclosure can provide for a computer program product, comprising a computer usable medium having a computer-readable program code or program instructions embodied therein, said computer-readable program code adapted to be executed to implement one or more functions specified in the flow diagram block or blocks. The computer program instructions can also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and datastores can be in communication with each other and/or other datastores, such as a centralized datastore, or other types of data storage devices. When needed, data or information stored in a memory or datastore can be transmitted to a centralized datastore capable of receiving data, information, or data records from more than one datastore or other data storage devices. In other embodiments, the datastores shown can be integrated or distributed into any number of datastores or other data storage devices.

It should be understood that the original applicant herein determines which technologies to use and/or productize based on their usefulness and relevance in a constantly evolving field, and what is best for it and its players and users. Accordingly, it can be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

In examples, aspects of the claimed subject matter can be practiced in distributed computing environments where certain tasks are performed by remote processing devices that are linked through a communications network. In a distributed computing environment, program functions can be located in both local and remote memory storage devices.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

The disclosure is described above with reference to block and flow diagrams of systems, methods, apparatuses, and/or computer program products according to examples of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams need not necessarily be performed in the order presented or need not necessarily be performed at all, according to some examples of the disclosure.

Computer-executable program instructions can be loaded onto a general-purpose computer, a special-purpose computer, a processor, or other programmable data processing apparatus to produce a particular machine, such that the instructions that execute on the computer, processor, or other programmable data processing apparatus implement one or more functions specified in the flowchart block or blocks. These computer-program instructions can also be stored in a computer-readable memory that can direct a computer or other programmable data processing apparatus to function in a particular manner, such that the instructions stored in the computer-readable memory produce an article of manufacture including instruction that implement one or more functions specified in the flow diagram block or blocks. Examples of the disclosure provide for a computer program product, comprising a computer usable medium having a computer-readable program code or program instructions embodied therein, the computer-readable program code adapted to be executed to implement one or more functions specified in the flow diagram block or blocks. The computer-program instructions can also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database can be transmitted to a centralized database capable of receiving data, information, or data records from more than one database or other data storage devices. In some embodiments, the databases shown can be integrated or distributed into any number of databases or other data storage devices.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system, comprising:
one or more processors; and
one or more computer-readable media storing computer-executable instructions that, when executed by the one or more processors, cause the one or more processors to:
receive gameplay data associated with playstyle of a player in one or more games;
receive persona data associated with the player and the gameplay data;
generate an animation for the player based on the gameplay data associated with the playstyle of the player in the one or more games;
dynamically generate, based at least in part on a portion of the playstyle of the player, content including personalized animation, wherein the content including personalized animation is dynamically generated personalized content associated with the player; and
transmit the content including personalized animation for presentation in a game associated with the player.

2. The system as recited by claim 1, wherein the content including the personalized animation is dynamically generated personalized content in a game currently being played by the player.

3. The system as recited by claim 1, wherein the content including personalized animation is further based on additional gameplay data associated with additional gameplay of the player in one or more additional games.

4. The system as recited by claim 1, wherein the content including personalized animation is further based on an animation modifier.

5. The system as recited by claim 1, wherein the computer-executable instructions, when executed by the one or more processors, further cause the one or more processors to:
access a dynamic generation algorithm or model from a datastore, the dynamic generation algorithm or model associated with the gameplay based on the persona of the player;
input at least a portion of the gameplay data to the dynamic generation algorithm or model;
receive a result of the dynamic generation algorithm or model; and
transmit the result of the dynamic generation algorithm or model as part of the content including the personalized animation for presentation in the game associated with the player.

6. The system as recited by claim 1, wherein the computer-executable instructions, when executed by the one or more processors, further cause the one or more processors to:
receive motion-capture data associated with an actor or athlete;
receive a request for personalized animation based on the playstyle of the player;
input the motion-capture data associated with the actor or athlete and at least a portion of the gameplay data including playstyle of the player into a dynamic generation algorithm or model;
receive a result of the dynamic generation algorithm or model; and
transmit the result of the dynamic generation algorithm or model as part of the content including the personalized animation for presentation in the game associated with the player.

7. The system as recited by claim 6, wherein the dynamic generation algorithm or model is configured to map at least a portion of the playstyle of the player to at least a portion of the motion-capture data associated with the actor or athlete.

8. A computer-implemented method, comprising:
receiving gameplay data associated with playstyle of a player in one or more games;
receiving persona data associated with the player and the gameplay data;
generating an animation of the player based on the gameplay data associated with the playstyle of the player in the one or more games;
dynamically generating, based at least in part on a portion of the playstyle of the player, content including personalized animation, wherein the content including personalized animation is dynamically generated personalized content associated with the player; and
transmitting the content including personalized animation for presentation in a game associated with the player.

9. The computer-implemented method of claim 8, wherein the content including the personalized animation is dynamically generated personalized content in a game currently being played by the player.

10. The computer-implemented method of claim 8, wherein the generating the content including personalized animation is further based on additional gameplay data associated with additional gameplay of the player in one or more additional games.

11. The computer-implemented method of claim 8, the method further comprising:
accessing a dynamic generation algorithm or model from a datastore, the dynamic generation algorithm or model associated with the gameplay based on the persona of the player;
inputting at least a portion of the gameplay data to the dynamic generation algorithm or model;
receiving a result of the dynamic generation algorithm or model; and
transmitting the result of the dynamic generation algorithm or model as part of the content including the personalized animation for presentation in the game associated with the player.

12. The computer-implemented method of claim 8, the method further comprising:
receiving motion-capture data associated with an actor or athlete;
receiving a request for personalized animation based on the playstyle of the player;
inputting the motion-capture data associated with the actor or athlete and at least a portion of the gameplay data including playstyle of the player into a dynamic generation algorithm or model;
receiving a result of the dynamic generation algorithm or model; and
transmitting the result of the dynamic generation algorithm or model as part of the content including the personalized animation for presentation in the game associated with the player.

13. The computer-implemented method of claim 12, the method further comprising mapping at least a portion of the playstyle of the player to at least a portion of the motion-capture data associated with the actor or athlete.

14. The computer-implemented method of claim 8, the method further comprising:
creating a blended animation associated with the playstyle of the player, wherein the content including the personalized animation is based on the blended animation.

15. One or more computer-readable media storing computer-executable instructions that, when executed by one or more processors, cause the one or more processors to perform operations comprising:
receiving gameplay data associated with playstyle of a player in one or more games;
receiving persona data associated with the player and the gameplay data;
generating an animation of the player based on the gameplay data associated with the playstyle of the player in the one or more games;
dynamically generating, based at least in part on a portion of the playstyle of the player, content including personalized animation, wherein the content including personalized animation is dynamically generated personalized content associated with the player; and
transmitting the content including personalized animation for presentation in a game associated with the player.

16. The one or more computer-readable media claim 15 recites, wherein the content including the personalized animation is dynamically generated personalized content in a game currently being played by the player.

17. The one or more computer-readable media claim 15 recites, wherein the generating the content including personalized animation is further based on additional gameplay data associated with additional gameplay of the player in one or more additional games.

18. The one or more computer-readable media claim 15 recites, the operations further comprising:
access a dynamic generation algorithm or model from a datastore, the dynamic generation algorithm or model associated with the gameplay based on the persona of the player;
inputting at least a portion of the gameplay data to the dynamic generation algorithm or model;
receiving a result of the dynamic generation algorithm or model; and
transmitting the result of the dynamic generation algorithm or model as part of the content including the personalized animation for presentation in the game associated with the player.

19. The one or more computer-readable media claim 15 recites, the operations further comprising:
receiving motion-capture data associated with an actor or athlete;
receiving a request for personalized animation based on the playstyle of the player;
inputting the motion-capture data associated with the actor or athlete and at least a portion of the gameplay data including playstyle of the player into a dynamic generation algorithm or model;
receiving a result of the dynamic generation algorithm or model; and
transmitting the result of the dynamic generation algorithm or model as part of the content including the personalized animation for presentation in the game associated with the player.

20. The one or more computer-readable media claim 15 recites, the operations further comprising:
configuring an animation modifier to create a blended animation.
